(19) United States
(12) Patent Application Publication
(10) Pub. No.: US 2017/0338063 A1
(43) Pub. Date: Nov. 23, 2017

(54) TOGGLE SWITCH LOCKOUT

(71) Applicant: Caterpillar Inc., Peoria, IL (US)

(72) Inventors: Kevin J. Auskings, Bloomington, IL (US); Mary A. Nsunwara, Decatur, IL (US)

(73) Assignee: Caterpillar Inc., Peoria, IL (US)

(21) Appl. No.: 15/160,049

(22) Filed: May 20, 2016

(51) Int. Cl. H01H 9/28

(52) U.S. Cl. CPC H01H 9/283; H01H 2239/032

(57) ABSTRACT

The present disclosure relates to a toggle switch lockout for disabling a toggle switch including a baseplate and two parallel legs attached to the baseplate. The parallel legs can be configured to be positioned on either side of a toggle switch. The parallel legs each can have a tapered cutout. The tapered cutouts can be configured to receive a lockout device that maintains the toggle switch in one position. The tapered cutout can be egg-shaped, with one end wider than the other end.

### TECHNICAL FIELD

The present disclosure relates to a toggle switch lockout, and more particularly, to a toggle switch lockout that can accommodate a variety of locks or hasps.

### BACKGROUND

Devices for locking electrical switches in one of their operating states, and particularly, the locking of electrical switches that are mounted on control panels are disclosed herein.

There are many instances where it is desirable to lock electrically controlled equipment by disabling a switch. For example, in industrial applications safety standards may require that equipment be de-energized and locked in this state while maintenance is performed, or that certain equipment always remain operative while particular procedures are being performed. Traditionally, such switches have handles or hasps to which locks can be applied, or the switches are mounted in enclosures which can be locked.

As industrial equipment becomes more automated, manual controls have become more centralized. Whereas in the past, control switches may have been disconnects located near the equipment in lockable enclosures, industrial automation has produced centralized control panels with numerous manually operable switches and displays. In addition, industrial control systems are usually programmable and the function performed by control panel switches can be changed without rewiring them. There is a need for lockout devices which can be easily applied to control panel toggle switches in the event their operation must be securely controlled.

A lockout device disclosed in U.S. Pat. No. 5,868,242 includes a cover with one leg and a base with another leg. The cover flips up and down as needed. When the cover is flipped down, the two legs are adjacent to each other and can receive a locking device. The cover maintains the toggle switch in a down position. However, the lockout device is sized to receive a limited number of locks due to the sizing of the cutouts in the legs and further requires an operator to flip the cover up and down. Accordingly, there is a need for lockout devices that can be used quickly by an operator and can receive different size locks or lockout hasps.

### SUMMARY OF THE INVENTION

In one aspect, the present disclosure relates to a toggle switch lockout for disabling a toggle switch including a baseplate, two parallel legs attached to the baseplate and configured to be positioned on either side of a toggle switch. Each of the parallel legs includes a tapered cutout. The tapered cutouts are configured to receive a lockout device that maintains the toggle switch in one position.

The tapered cutout can be tear-drop shaped, triangle shaped, or egg-shaped. The toggle switch lockout can maintain the toggle switch in a locked position. An outer portion of the parallel legs can include a curved indent positioned above the tapered cutout.

The baseplate can be configured to be affixed to a control panel including a toggle switch. The baseplate can include a hole for affixing the toggle switch lockout to a control panel.

In another aspect, the present disclosure relates to a toggle switch lockout system including a toggle switch and a toggle switch lockout. The toggle switch lockout includes a baseplate and two parallel legs coupled to the baseplate. The parallel legs can be positioned on either side of the toggle switch. The two parallel legs can include a tapered cutout. The toggle switch lockout can be configured to receive a lockout device that holds the toggle switch in one position.

The tapered cutout can be tear-drop shaped, triangle shaped, or egg-shaped. The toggle switch lockout can maintain the toggle switch in a locked position. An outer portion of the parallel legs can include a curved indent positioned above the tapered cutout.

The baseplate can be configured to be affixed to a control panel including a toggle switch. The baseplate can include a hole for affixing the toggle switch lockout to a control panel. The toggle switch lockout system can further include a locking device positioned in the tapered cutouts and configured to lock the toggle switch in one position.

### BRIEF DESCRIPTION OF THE DRAWINGS

FIG. 1 illustrates a toggle switch lockout of the present disclosure;

FIG. 2 is a side view of the toggle switch lockout of FIG. 1;

FIG. 3 is a top view of the toggle switch of FIG. 1; and

FIG. 4 is a toggle switch lockout of the present disclosure with a toggle switch and a locking device.

### DETAILED DESCRIPTION

The present disclosure relates to toggle switch lockouts as described in further detail below. Referring to FIG. 1, a toggle switch lockout 100 of the present disclosure is exemplified. The toggle switch lockout 100 includes a baseplate 102 and two parallel legs 104 coupled to the baseplate 102 at a first end of the toggle switch lockout 100. The parallel legs 104 include wedge-shaped or tapered cutouts 106 located at a second end of the toggle switch lockout 100.

The toggle switch lockout 100 can be positioned with the parallel legs 104 positioned on either side of a toggle switch, such that when a locking device 114 is employed, the tapered cutouts 106 and the shackle 116 of the locking device 114 prevent the toggle switch 112 from being switched to the down position. For example, the baseplate 102 can be positioned above the toggle switch 112 that requires a toggle switch lockout 100. The toggle switch lockout 100 can be positioned when and where the operator requires.

The tapered cutouts 106 are configured to receive locking devices with varying dimensions on the shackle or hasp. Locking devices, such as padlocks, combination locks, or lockout hasps, are used in lockout devices to lock a switch. A lockout hasp can include a lockout for one operator or multiple operators. Different locking devices can have different widths and curvatures on the shackle or hasp. The tapered cutout 106 of the toggle switch lockout 100 of the present disclosure can accommodate locking devices with a variety of widths and curvatures.

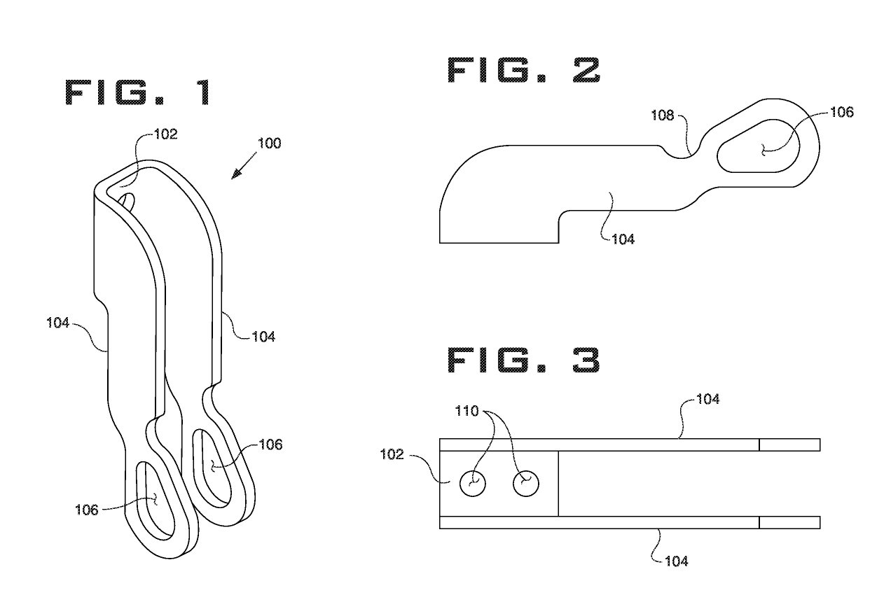

FIG. 2 is a side view of the toggle switch lockout 100. The tapered cutout 106 can be a variety of tapered shapes. For example, the tapered cutout 106 can be tear-drop shaped, ovoid, elliptical shaped, egg-shaped or triangular shaped. Specifically, the tapered cutout 106 can be wider at one end than the other end. In FIG. 2, the tapered cutout 106 is positioned at a second end of the parallel leg 104 away from the baseplate 102. The tapered cutout 106 of FIG. 2 is egg-shaped and is wider at one end than the other end.

Still referring to FIG. 2, the parallel leg 104 includes a curved indent 108 positioned above the tapered cutout 106 away from the second end of the parallel leg 104. The curved indent 108 allows an operator to easily access the toggle switch 112. For example, if there is no locking device in the tapered cutout 106, the curved indent 108 enables an operator to access the toggle switch to move it between an up position and a down position.

FIG. 3 is a top side view of the toggle switch lockout 100. The baseplate 102 can include a hole 110. The baseplate 102 can include more than one hole 110, as needed. The hole 110 can accept a screw or other fastener to affix the toggle switch lockout 100 to a control panel or a panel that includes a toggle switch 112. The holes 110 enables an operator to position the toggle switch lockout 100 wherever needed around a toggle switch 112.

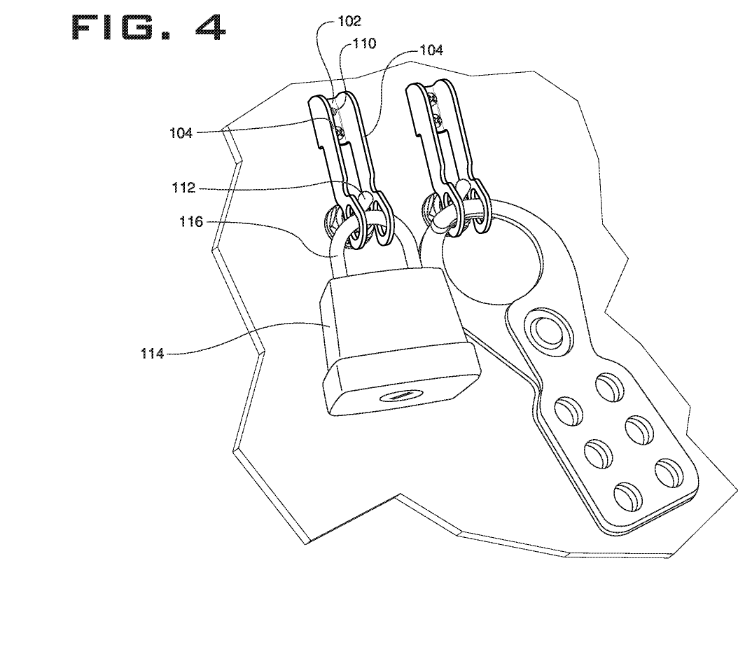

FIG. 4 shows the toggle switch lockout 100 of the present disclosure with a toggle switch 112. A locking device 114 locks the toggle switch 112 in one position, for example, in an up position. Specifically, a shackle 116 on the locking device 114 can be inserted through the tapered cutouts 106. The shackle 116 can prevent the toggle switch 112 from switching to the down position until an operator (or operators) removes the locking device.

The toggle switch lockout 100 can be made from any material with sufficient structural integrity. For example, the toggle switch lockout 100 can be made from metal, plastic, or a combination.

### INDUSTRIAL APPLICABILITY

The toggle switch lockout 100 of the present disclosure allows an operator to use a locking device 114 of their choice, such as a padlock or a single or multiple operator lockout hasp. The operator can flip a toggle switch 112 into an up position and then insert a shackle 116 of the locking device 114 in the tapered cutouts 106 of the toggle switch lockout. The shackle 116 of the locking device 114 prevents the toggle switch from moving to the down position. The toggle switch lockout 100 can accommodate a variety of shackle or hasp widths and curvatures because of the shape of the tapered cutouts 106, which also prevents the toggle switch 112 from moving to a down position.

The toggle switch lockout 100 of the present disclosure enables an operator to quickly flip the toggle switch 112 to an up position and insert a locking device 114. Because the toggle switch lockout 100 will accommodate a variety of locking devices 114, the operator can quickly choose a locking device 114 that suits his or her needs. Accordingly, the toggle lockout switch of the present disclosure saves an operator time and prevents frustration.

It will be apparent to those skilled in the art that various modification and variations can be made to the disclosed toggle switch lockout. Other embodiments will be apparent to those skilled in the art from consideration of the specification and practice of the disclosed composition. It is intended that the specification and example be considered as exemplary only, with a true scope being indicated by the following claims and their equivalents.

What is claimed is:

1. A toggle switch lockout for disabling a toggle switch comprising a baseplate; two parallel legs attached to the baseplate and configured to be positioned on either side of a toggle switch; wherein each of the two parallel legs have a tapered cutout; and wherein the tapered cutouts are configured to receive a lockout device that maintains the toggle switch in one position.

2. The toggle switch lockout of claim 1, wherein the tapered cutout is tear-drop shaped.

3. The toggle switch lockout of claim 1, wherein the tapered cutout is triangle shaped.

4. The toggle switch lockout of claim 1, wherein the tapered cutout is egg-shaped.

4. The toggle switch lockout of claim 1, wherein the one position is a locked position for the toggle switch.

5. The toggle switch lockout of claim 1, wherein the baseplate is configured to be affixed to a control panel including a toggle switch.

6. The toggle switch lockout of claim 1, wherein the baseplate comprises a hole for affixing the toggle switch lockout to a control panel.

7. The toggle switch lockout of claim 1, wherein an outer portion of the parallel legs comprises a curved indent positioned above the tapered cutout.

8. A toggle switch lockout system comprising:
a toggle switch; and
a toggle switch lockout comprising a baseplate and two parallel legs coupled to the baseplate and positioned on either side of the toggle switch;
wherein each of the two parallel legs have a tapered cutout; and
wherein the toggle switch lockout is configured to receive a lockout device that holds the toggle switch in one position.

9. The toggle switch lockout system of claim 14, wherein the tapered cutout is tear-drop shaped.

10. The toggle switch lockout system of claim 14, wherein the tapered cutout is triangle shaped.

11. The toggle switch lockout system of claim 14, wherein the tapered cutout is egg-shaped.

12. The toggle switch lockout system of claim 14, wherein the one position is a locked position for the toggle switch.

13. The toggle switch lockout system of claim 14, wherein the baseplate is configured to be affixed to a control panel including a toggle switch.

14. The toggle switch lockout system of claim 14, wherein the baseplate comprises a hole for affixing the toggle switch lockout to a control panel.

15. The toggle switch lockout system of claim 14 further comprising a locking device positioned in the tapered cutouts and configured to lock the toggle switch in one position.
